(19) United States
(12) Patent Application Publication
(10) Pub. No.: US 2019/0036817 A1
(43) Pub. Date: Jan. 31, 2019

(54) TRANSPORT NETWORK CONTROL APPARATUS, COMMUNICATION SYSTEM, FORWARDING NODE CONTROL METHOD, AND PROGRAM

(71) Applicant: NEC Corporation, Minato-ku, Tokyo (JP)

(72) Inventors: Kazuya SUZUKI, Tokyo (JP); Hiroya KANEKO, Tokyo (JP); Hajime AIZAWA, Tokyo (JP)

(73) Assignee: NEC Corporation, Minato-ku, Tokyo (JP)

(21) Appl. No.: 16/072,580

(22) PCT Filed: Mar. 16, 2017
(86) PCT No.: PCT/JP2017/010698

§ 371 Date: Jul. 25, 2018

(30) Foreign Application Priority Data
Mar. 22, 2016 (JP) 2016-056847

(51) Int. Cl. H04L 12/721; H04L 12/713; H04L 12/753; H04L 12/741

(52) U.S. Cl. CPC H04L 45/66; H04L 45/586; H04L 12/4641; H04L 45/48; H04L 45/745; H04L 45/12

(57) ABSTRACT

A transport network control apparatus includes a unit configured to acquire, from a cloud management system configured to manage a first base and a second base that are connected via a transport network configured to provide a layer 2 connection service, a MAC address to be used for a frame that is transmitted from any one of the bases, a unit configured to compute, on the transport network, a forwarding path for forwarding the frame between the first and second bases using the MAC address as a destination, and a unit configured to set, in a forwarding node on the transport network, a forwarding rule for causing the frame to be forwarded along the computed forwarding path.

### CROSS-REFERENCE TO RELATED APPLICATIONS

This application is a National Stage Entry of PCT/JP2017/010698 filed on Mar. 16, 2017, which claims priority from Japanese Patent Application 2016-056847 filed on Mar. 22, 2016, the contents of all of which are incorporated herein by reference, in their entirety.

### FIELD

The present invention is based upon and claims the benefit of the priority of Japanese Patent Application No. 2016-056847 (filed on Mar. 22, 2016), the disclosure of which is incorporated herein in its entirety by reference.

The present invention relates to a transport network control apparatus, a communication system, a forwarding node control method, and a program. More specifically, the invention relates to a transport network control apparatus, a communication system, a forwarding node control method, and a program for providing a layer 2 connection service (bridging connection service) between bases.

### BACKGROUND

Patent Literature 1 discloses an example of a control apparatus for a concentrated management type network represented by OpenFlow. Patent Literature 2 discloses an example of a method of determining forwarding information to be used by a forwarding node in a packet forwarding network, for forwarding of a packet.

Paragraph [0061] in Patent Literature 3 describes that “in a cloud computing virtualization data center, . . . , both of a MAC address and an IP address of a virtual host are managed by a cloud management system, and allocated. Accordingly, in this case, the correspondence between the IP and the MAC of each virtual host can be directly set in an ARP server by the cloud management system”. Patent Literature 4 discloses a communication system that can be implemented by using a simplified forwarding table and can also be applied for path control of a data packet.

[Patent Literature 1]

JP Patent Kokai Publication No. JP-P-2014-138244A

[Patent Literature 2]

JP Patent Kokai Publication No. JP-P-2014-17842A

[Patent Literature 3]

JP Patent Kohyo Publication No. JP-P-2013-532927A

[Patent Literature 4]

JP Patent Kokai Publication No. JP-P-2014-207716A

### SUMMARY

The following analysis has been given by the present invention. When bases such as data centers are connected by a layer 2 network, MAC (Media Access Control) [addresses] are present in one network. There is a problem that an increase in MAC addresses will bring about an increase in flooding traffic for learning an unlearned frame(s) and a large amount of network resources (such as a bandwidth (data transfer speed) and a copy processing load) will be consumed. Further, in such a case as that where a virtualization server is disposed in a data center, the number of the MAC addresses will further increase.

Further, when looping occurs due to a reason such as a change in a network configuration, the entirety of the network may be seriously affected.

It is an object of the present invention to provide a transport network control apparatus, a communication system, a forwarding node control method, and a program that can contribute to reduction of consumption of network resources due to an increase in MAC addresses in a layer 2 network that connect bases, mentioned above.

According to a first aspect, there is provided a transport network control apparatus comprising a unit configured to acquire, from a cloud management system configured to manage a first base and a second base that are connected via a transport network configured to provide a layer 2 connection service, a MAC address to be used for a frame that is transmitted from any of the bases. This transport network control apparatus further comprises a unit configured to compute, on the transport network, a forwarding path for forwarding the frame between the first and second bases using the MAC address as a destination. This transport network control apparatus further comprises a unit configured to set, in a forwarding node on the transport network, a forwarding rule for causing the frame to be forwarded along the computed forwarding path.

According to a second aspect, there is provided a communication system including the transport network control apparatus and at least one forwarding node on the transport network.

According to a third aspect, there is provided a forwarding node control method comprising, by a transport network control apparatus connected to a cloud management system configured to manage a first base and a second base that are connected via a transport network configured to provide a layer 2 connection service, acquiring, from the cloud management system, a MAC address to be used for a frame that is transmitted from any one of the bases; computing, on the transport network, a forwarding path for forwarding the frame between the first and second bases using the MAC address as a destination; and setting, in a forwarding node on the transport network, a forwarding rule for causing the frame to be forwarded along the computed forwarding path. This method is linked to a specific machine, which is the control apparatus configured to control the transport network configured to provide the layer 2 connection service.

According to a fourth aspect, there is provided a program configured to cause a computer comprising a transport network control apparatus connected to a cloud management system configured to manage a first base and a second base that are connected via a transport network configured to provide a layer 2 connection service to execute acquiring, from the cloud management system, a MAC address to be used for a frame that is transmitted from any one of the bases; computing, on the transport network, a forwarding path for forwarding the frame between the first and second bases using the MAC address as a destination; and setting, in a forwarding node on the transport network, a forwarding rule for causing the frame to be forwarded along the computed forwarding path. This program can be stored in a computer readable (non-transient) storage medium. That is, the present invention can also be embodied as a computer program product.

The meritorious effects of the present invention are summarized as follows.

According to the present invention, influence due to an increase in MAC addresses in a layer 2 network that connects bases can be reduced.

### BRIEF DESCRIPTION OF DRAWINGS

FIG. 1 is a diagram illustrating a configuration of an example embodiment of the present disclosure.

FIG. 2 is a diagram for explaining operations in the example embodiment of the present disclosure.

FIG. 3 is a diagram illustrating a configuration of a communication system in a first example embodiment of the present disclosure.

FIG. 4 is a diagram illustrating a configuration of a transport network control apparatus in the first example embodiment of the present disclosure.

FIG. 5 is a table illustrating an example of MAC address information held by the transport network control apparatus in the first example embodiment of the present disclosure.

FIG. 6 is a flow diagram illustrating operations of the transport network control apparatus in the first example embodiment of the present disclosure.

FIG. 7 is a diagram for explaining the operations of the transport network control apparatus in the first example embodiment of the present disclosure.

FIG. 8 is a diagram illustrating a configuration of a communication system in a second example embodiment of the present disclosure.

FIG. 9 is a diagram illustrating a configuration of a transport network control apparatus in the second example embodiment of the present disclosure.

FIG. 10 is a table illustrating an example of base information held by the transport network control apparatus in the second example embodiment of the present disclosure.

FIG. 11 is a diagram for explaining operations of a forwarding node that is controlled by the transport network control apparatus in the second example embodiment of the present disclosure.

FIG. 12 is a table for explaining a learning operation of the forward node that is controlled by the transport network control apparatus in the second example embodiment of the present disclosure.

FIG. 13 is a diagram illustrating a configuration of a communication system in a third example embodiment of the present disclosure.

FIG. 14 is a diagram illustrating a configuration of a transport network control apparatus in the third example embodiment of the present disclosure.

FIG. 15 is a table for explaining information held by the transport network control apparatus in the third example embodiment of the present disclosure.

FIG. 16 is a flow diagram illustrating operations of the transport network control apparatus in the third example embodiment of the present disclosure.

FIG. 17 is a diagram for explaining the operations of the transport network control apparatus in the third example embodiment of the present disclosure.

### PREFERRED MODES

First, an overview of an example embodiment of the present disclosure will be described with reference to the drawings. Reference numerals in the drawings given in this overview are given to respective elements for convenience as an example for helping understanding, and do not intend to limit the present disclosure to modes illustrated. Connection lines between blocks in the drawings to be used in the following description include bidirectional connection lines and monodirectional connection lines. Each monodirectional arrow schematically illustrates a main signal (data) flow, and does not exclude bidirectionality.

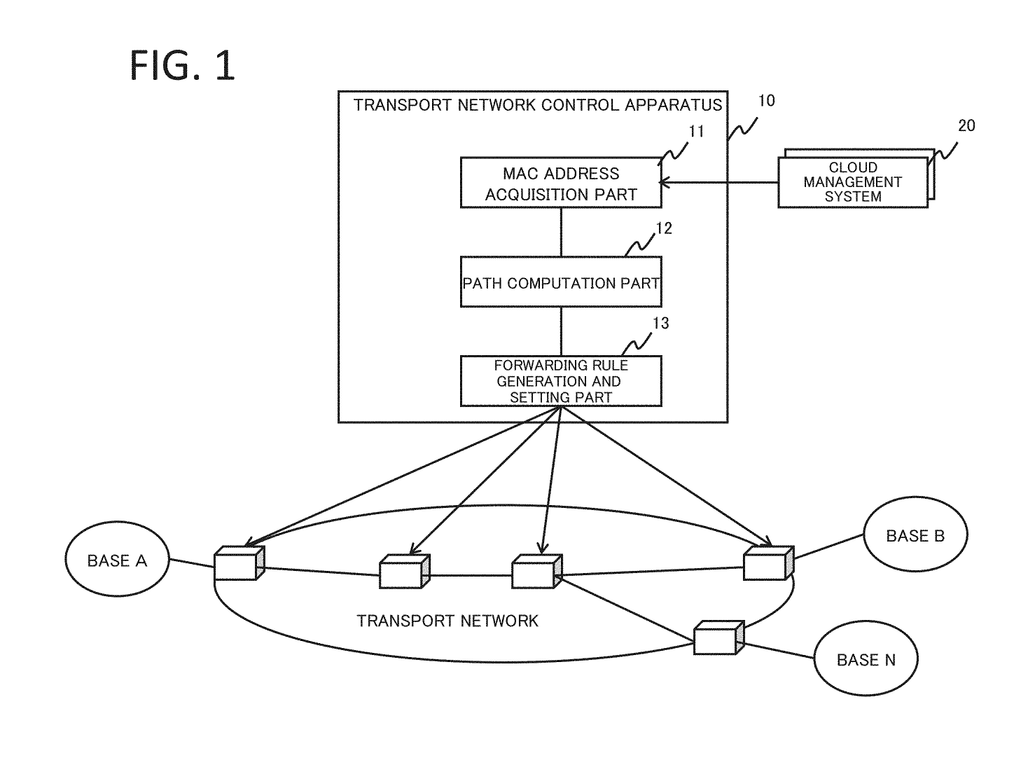

The example embodiment of the present disclosure can be implemented by a transport network control apparatus 10 including a MAC address acquisition part 11, a path computation part 12, and a forwarding rule generation and setting part 13, as illustrated in FIG. 1.

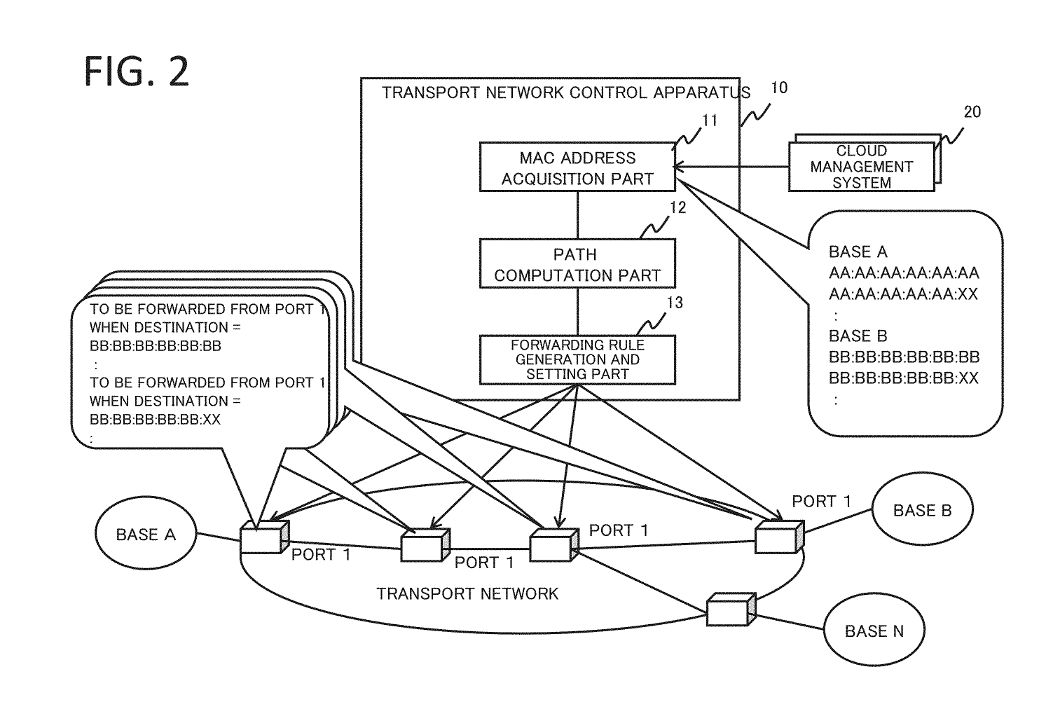

More specifically, the MAC address acquisition part 11 acquires, from a cloud management system 20 configured to manages first and second bases connected via a transport network configured to provide a layer 2 connection service, a MAC address to be used for a frame that is transmitted from each of the bases. To take an example, the MAC address acquisition part 11 acquires, from the cloud management system 20, MAC addresses for a terminal, a virtual machine, and the like that are present in the bases, as illustrated in a balloon on the right side of FIG. 2.

The path computation part 12 computes (calculates), on the transport network, a forwarding path for forwarding the frame between the first and second bases using the MAC address as a destination. To take an example, the path computation part 12 computes the forwarding path for forwarding the frame transmitted from a base A to a base B, as illustrated in FIG. 2.

The forwarding rule generation and setting part 13 sets, in forwarding nodes (concerned) on the transport network, a forwarding rule for causing the frame to be forwarded along the computed forwarding path. To take an example, the forwarding rule generation and setting part 13 sets, in nodes (concerned) on the transport network, the forwarding rule for causing the frame transmitted from the base A and addressed to the base B to be forwarded to the base B, as illustrated in a balloon on the left side of FIG. 2.

According to the above configuration, the path for forwarding the frame between the bases is computed, and the forwarding rule is set, in advance. Thus, flooding traffic for learning an unlearned frame(s) can be almost eliminated. Since the flooding traffic itself is reduced, influence of looping can also be reduced even if such a situation as occurrence of the looping occurs.

### First Example Embodiment

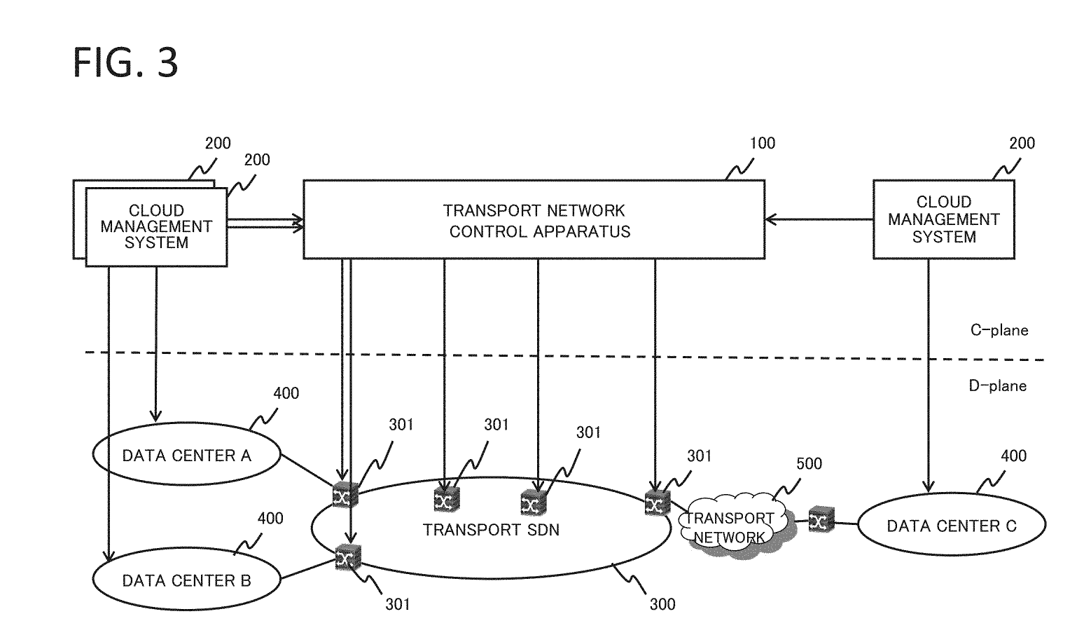

Then, a first example embodiment of the present disclosure will be described in detail, with reference to the drawings. FIG. 3 is a diagram illustrating a configuration of a communication system in the first example embodiment of the present disclosure. Referring to FIG. 3, a configuration including a cloud management system 200 configured to manage a data center A to a data center C, a transport SDN (Software Defined Network) 300 configured to make connections among these data centers, and a transport network control apparatus 100 configured to control the transport SND 300 is illustrated. The lower side of a broken line in FIG. 3 corresponds to a data plane (D-Plane) configured to perform transfer of user data and so on, and the upper side of the broken line in FIG. 3 corresponds to a control plane (C-Plane) configured to control this data plane. In the following example embodiments, an example of connecting the data centers is pointed out. Bases to be connected are not, however, limited to the data centers, and other information systems generally referred to as “clouds” may be used as the bases to be connected.

The cloud management systems 200 respectively manage data center(s) 400 (data centers A to C) under respective control. A cloud management platform such as an Open Stack may be pointed out, as the cloud management system 200 as mentioned above.

The transport network control apparatus 100 is an apparatus configured to make a transport network an SDN. The transport network control apparatus 100 controls each forwarding node 301 on the transport SDN 300, thereby providing a layer 2 connection service (hereinafter referred to as an L2 connection service) among the data centers.

In the example in FIG. 3, the data center C is connected to the transport SDN (also written as a T-SDN) 300 via a (second) transport network 500 that is not controlled by the transport network control apparatus 100. The data center C may be, however, directly connected to the transport SDN 300.

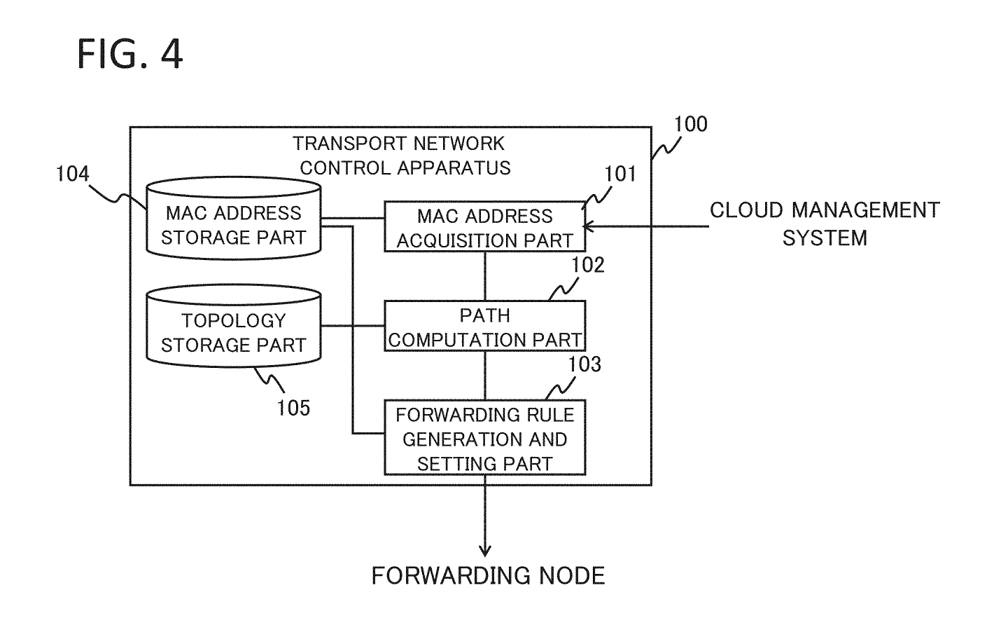

FIG. 4 is a diagram illustrating a detailed configuration of the transport network control apparatus 300 [sic. 100] in the first example embodiment of the present disclosure. Referring to FIG. 4, the configuration including a MAC address acquisition part 101, a path computation part 102, a forwarding rule generation and setting part 103, a MAC address storage part 104, and a topology storage part 105 is illustrated.

The MAC address acquisition part 101 is means for inquiring, to the cloud management system 200, about a list of MAC addresses that are present in each data center and acquiring a MAC address. In the case of the OpenStack, for example, the MAC address(es) can be acquired via an application program interface (API) of a network management component referred to as OpenStack Networking. The MAC address acquisition part 101 stores the acquired MAC address(es) in the MAC address storage part 104.

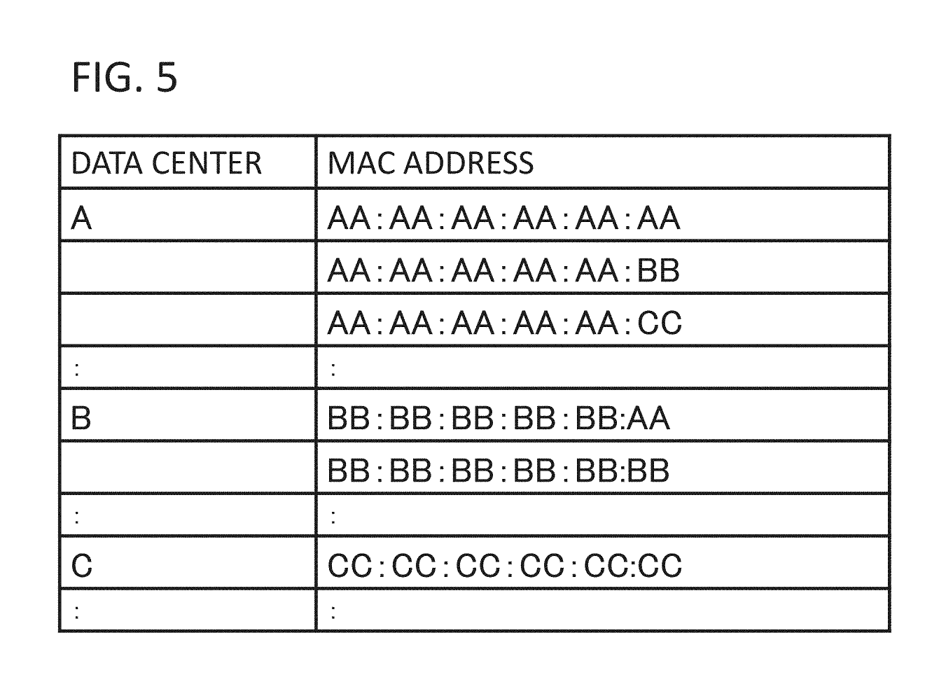

FIG. 5 is a table illustrating an example of a state where MAC addresses are held in the MAC address storage part 104. In the example in FIG. 5, a list of IDs for the data centers (corresponding to the above-mentioned “bases”) and the MAC addresses acquired from the data centers is stored.

The path computation part 102 refers to topology information stored in the topology storage part 105 and computes a forwarding path for forwarding a frame between the data centers that are different. The forwarding path as mentioned above can be obtained by computing a shortest path tree in an opposite direction using a certain one of the data centers as a root by Dijkstra's algorithm.

The forwarding rule generation and setting part 103 generates a forwarding rule for forwarding the frame between the data centers using the MAC address acquired by the MAC address acquisition part 101 as a destination, according to the forwarding path computed by the path computation part 102, and sets the forwarding rule in forwarding nodes 301 (concerned) on the forwarding path. To take an example, the forwarding rule generation and setting part 103 generates the forwarding rule in which a forwarding destination is set to a subsequent forwarding node (port) on the forwarding path from any one node (concerned), using a matching condition that the MAC address should be the MAC address held in the MAC address storage part 104. With respect to a frame between the bases in an opposite direction as well, the forwarding rule generation and setting part 103 can set a forwarding rule in which the computed forwarding path is shared, thereby implementing forwarding in the opposite direction.

Each part (processing means) in the transport network control apparatus 100 illustrated in FIG. 4 may also be implemented by a computer program to cause a computer configuring the transport network control apparatus 100 to execute each process described above, using hardware of the transport network control apparatus 100.

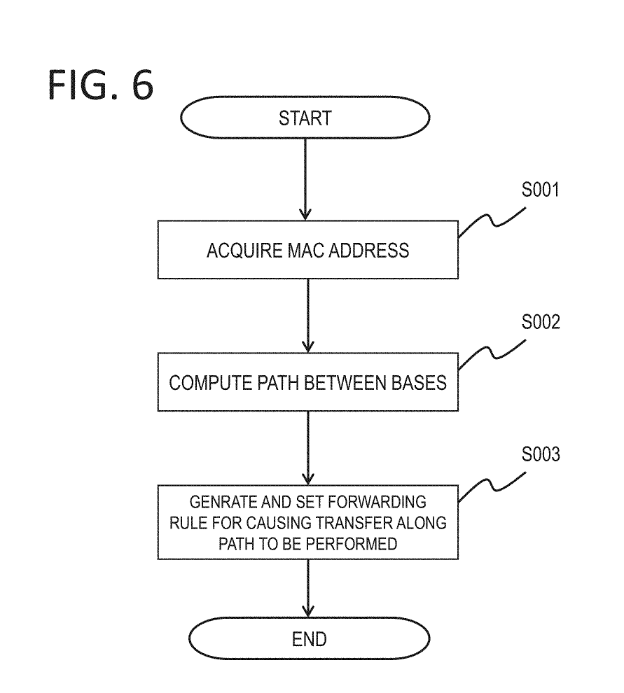

Then, operations in this example embodiment will be described in detail, with reference to the drawings. FIG. 6 is a flow diagram illustrating the operations of the transport network control apparatus in the first example embodiment of the present disclosure. Referring to FIG. 6, the transport network control apparatus 100 first acquires a MAC address from (any one of) the cloud management systems 200 configured to manage data center(s) 400 (concerned) that is under respective control and is connected to the transport SDN 300 (step S001).

Subsequently, the transport network control apparatus 100 computes a forwarding path for forwarding a frame between the data centers, by referring to the topology information stored in the topology storage part 105 (step S002).

Finally, the transport network control apparatus 100 sets a forwarding rule in each forwarding node 301 on the forwarding path so that the frame between the data centers properly reaches the data center of a destination, using the computed forwarding path and the acquired MAC address(es) (step S003).

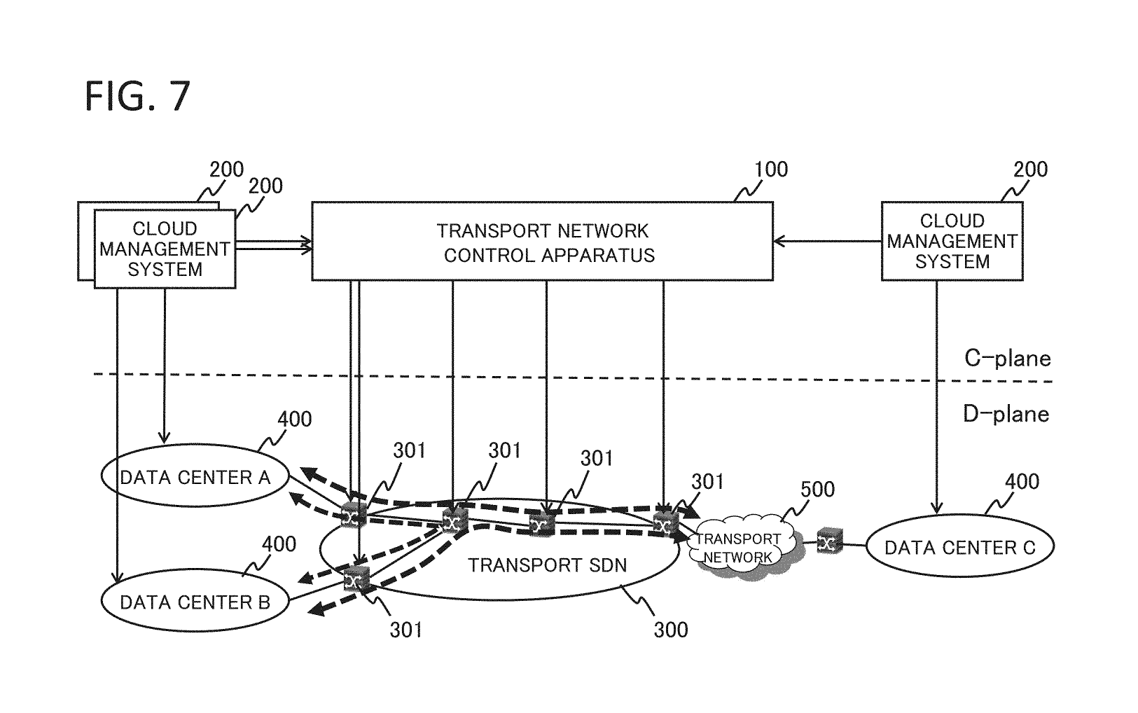

Setting of the information necessary for forwarding the frame between the data centers is completed by the above-mentioned processes. Thereafter, forwarding of the frame between the data centers becomes possible, as indicated by each thick broken line in FIG. 7.

As described above, according to this example embodiment, a situation, for example, does not occur where the forwarding node (edge node) of the transport SDN 300 connected to the data center A in FIG. 7 receives an unlearned frame from the data center A. The reason for that is that the MAC address which is present in the data center A is acquired in advance from the cloud management system (concerned) that manages the data center A and the necessary forwarding rule is set. Similarly, a situation does not occur where the forwarding node (edge node) of the transport SDN 300 connected to the data center B or C in FIG. 7 receives an unlearned frame from the side of the data center B or C. As a result, flooding traffic to be triggered by reception of the unlearned frame can be greatly reduced. Reduction of the flooding traffic also reduces a load such as copying or forwarding of the unlearned frame in each of forwarding nodes.

### Second Example Embodiment

Subsequently, a description will be given about a second example embodiment in which a configuration has been assumed where data center(s) that accommodates the method in the first example embodiment and data center(s) that does not accommodate the method in the first example embodiment due to the reason that a cloud management system is not present or the like are connected to a transport SDN 300.

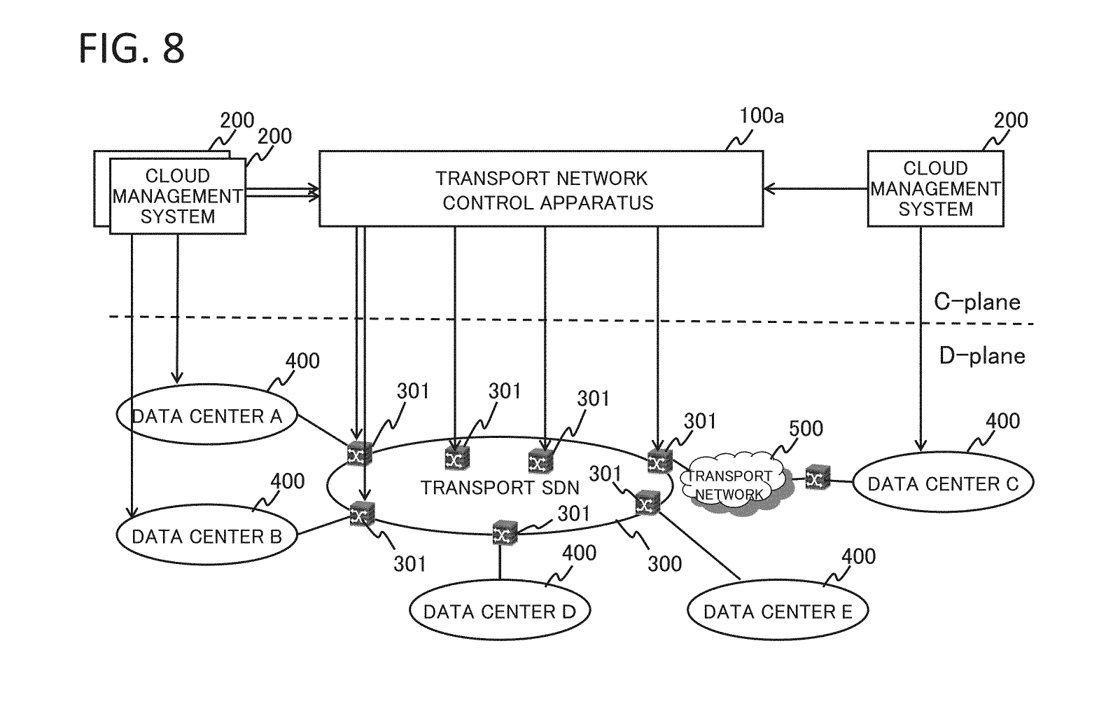

FIG. 8 is a diagram illustrating a configuration of a communication system in the second example embodiment of the present disclosure. A difference from the communication system in the first example embodiment illustrated in FIG. 3 is that data centers D and E that do not accommodate the method in the first embodiment or that can acquire no MAC address from a cloud management system 200 are connected to the transport SDN 300. Since a basic configuration and operations are similar to those in the first example embodiment, a description will be hereinafter given by centering on other differences.

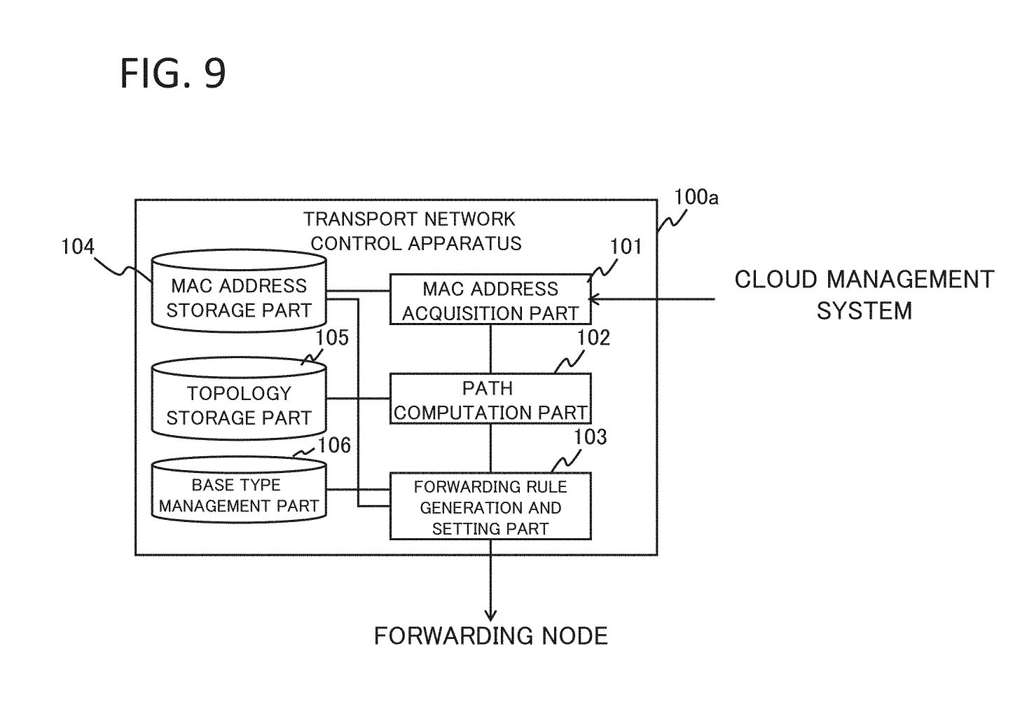

FIG. 9 is a diagram illustrating a configuration of a transport network control apparatus 100a in the second example embodiment of the present disclosure. A difference from the transport network control apparatus 100 in the first example embodiment illustrated in FIG. 4 resides in that a base type management part 106 is added.

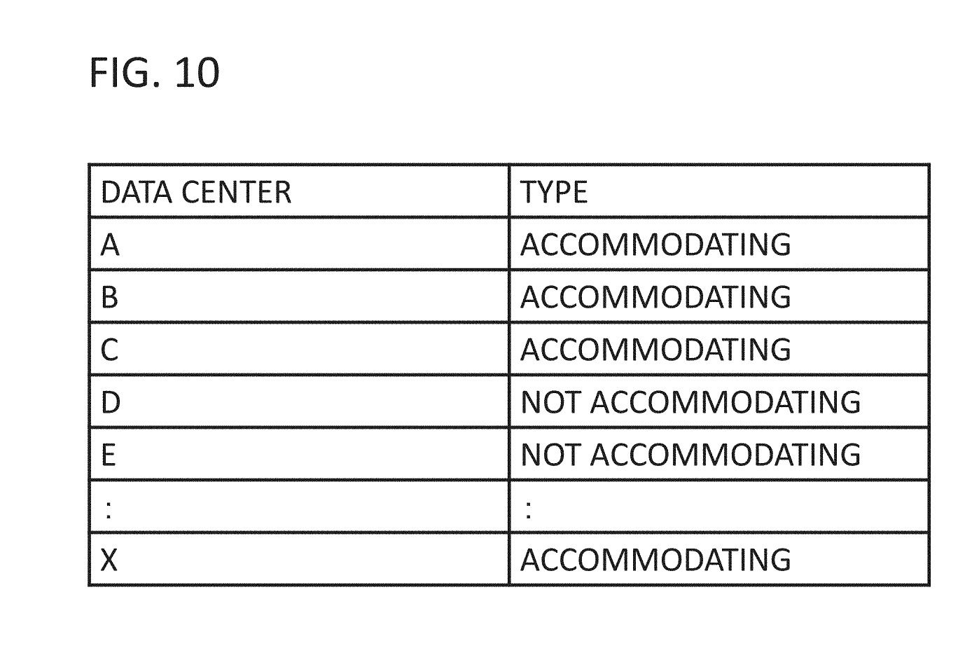

FIG. 10 is a table illustrating an example of base information (data center information) held in the base type management part 106 of the transport network control apparatus 100a in the second example embodiment. Referring to FIG. 10, for each data center, whether or not the data center accommodates the method (method of setting a forwarding rule in advance using a MAC address) in the first embodiment is registered. In the example in FIG. 10, the data center D and the data center E are data centers that can acquire no MAC address from the cloud management system 200. Thus, the data center D and the data center E are each described as “not accommodating” the method of setting the forwarding rule in advance using the MAC address. As the case where the data center D and the data center E are each “not accommodating” the method of setting the forwarding rule in advance using the MAC address, a case where the cloud management system 200 does not permit provision of any MAC address is also included.

According to the configuration in this example embodiment, the transport network control apparatus 100a acquires no MAC addresses in the data center D and E. Therefore, when a forwarding node (edge node) of the transport SDN 300 connected to a data center A receives a frame addressed to the data center D (having a destination MAC address=XX:XX:XX:XX:XX:XX), the frame is recognized as an unlearned frame.

However, the transport network control apparatus 100a in this example embodiment sets, in a forwarding node (edge) node 301 of the transport SDN 300 connected to the data center A, such a forwarding rule as that where each unlearned frame is transmitted only to the data centers D and E which do “not accommodate” the method of setting the forwarding rule in advance using the MAC address. This forwarding rule can be generated, for example, by further excluding ports connected to data centers B and C, from ports other than the receiving port of the Unknown frame which serves as the forwarding destination of the Unknown frame.

The reason why forwarding to the data centers B and C can be omitted (or suppressed) is that, since the MAC address(es) to be used for a frame between the data centers A and B, the data centers A and C, or the data centers B and C is(are) acquired in advance and already set in the forwarding rule, there is no need for learning, as described in the first example embodiment.

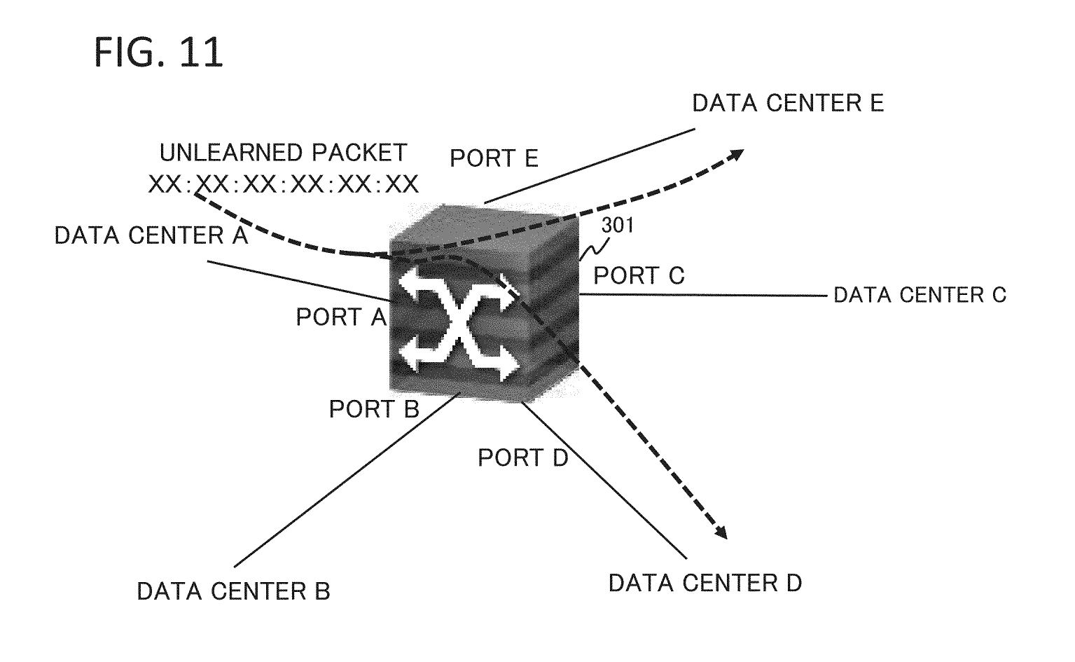

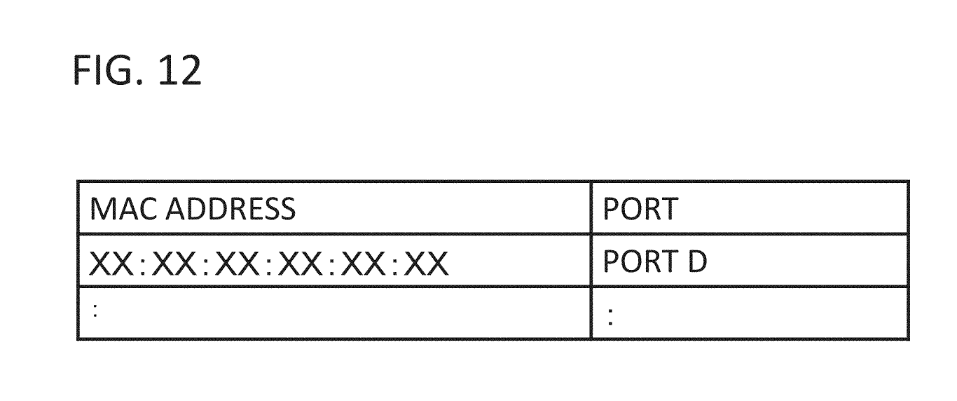

As a result of forwarding of the unlearned frame, a response is obtained from a terminal or the like of one of the data centers D and E or the data center D, for example. In this case, the forwarding node (edge node) 301 of the transport SDN 300 connected to the data center A in FIG. 11 registers the relationship between the destination MAC address and the receiving port of the unlearned frame in a MAC address table, as illustrated in FIG. 12. Thereafter, when the forwarding node (edge node) of the transport SDN 300 connected to the data center A in FIG. 11 receives a frame having the destination MAC address of XX:XX:XX:XX:XX:XX, the forwarding node performs unicast forwarding to a port D connected to the data center D.

As mentioned above, the present disclosure can be applied even to the environment in which the data centers managed by the cloud management system and the data centers not managed by the cloud management system are mixed, without problems. Further, as clear from FIG. 11 as well, it is so configured that even when the unlearned frame has arrived, the unlearned frame is copied just corresponding to the necessary number of the data centers and is forwarded to the necessary number of the data centers rather than being transmitted to all the bases. Thus, consumption of network resources is also reduced.

In the above-mentioned example embodiment, the description has been given, assuming that whether or not any one of data centers is to be a target of transmission of an unlearned frame is switched according to whether or not the data center accommodates the method (method of setting the forwarding rule in advance using the MAC address) in the first example embodiment. It may also be so arranged that a certain data center is set to a target of transmission of an unlearned frame according to other aspects. To take an example, when even one of the data centers managed by the cloud management system desires to perform leaning of a MAC address, the type field of the table illustrated in FIG. 10 is set to “not accommodating”, thereby making it possible for the data center to become a target of transmission of an unlearned frame. When a MAC address cannot be acquired from the cloud management system 200 or when there is a terminal having a MAC address not managed by the cloud management system in one of the data centers, for example, “not accommodating” can also be deliberately set.

### Third Example Embodiment

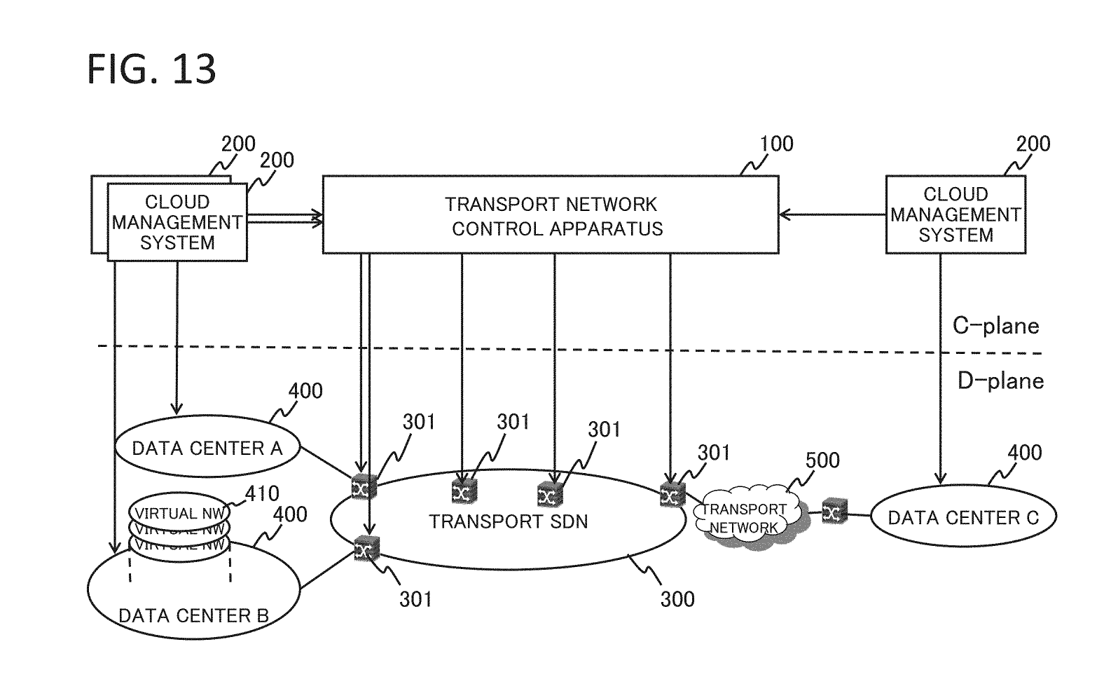

Subsequently, a description will be given about a third example embodiment that has been assumed as a configuration in which a plurality of virtual networks are constructed on a data center in the method in the first example embodiment. FIG. 13 is a diagram illustrating a configuration of a communication system in the third example embodiment of the present disclosure. A difference from the first example embodiment illustrated in FIG. 3 resides in that a plurality of virtual networks 410 are constructed on a data center B. Since a basic configuration and operations are similar to those in the first example embodiment, a description will be hereinafter given by centering on other different points.

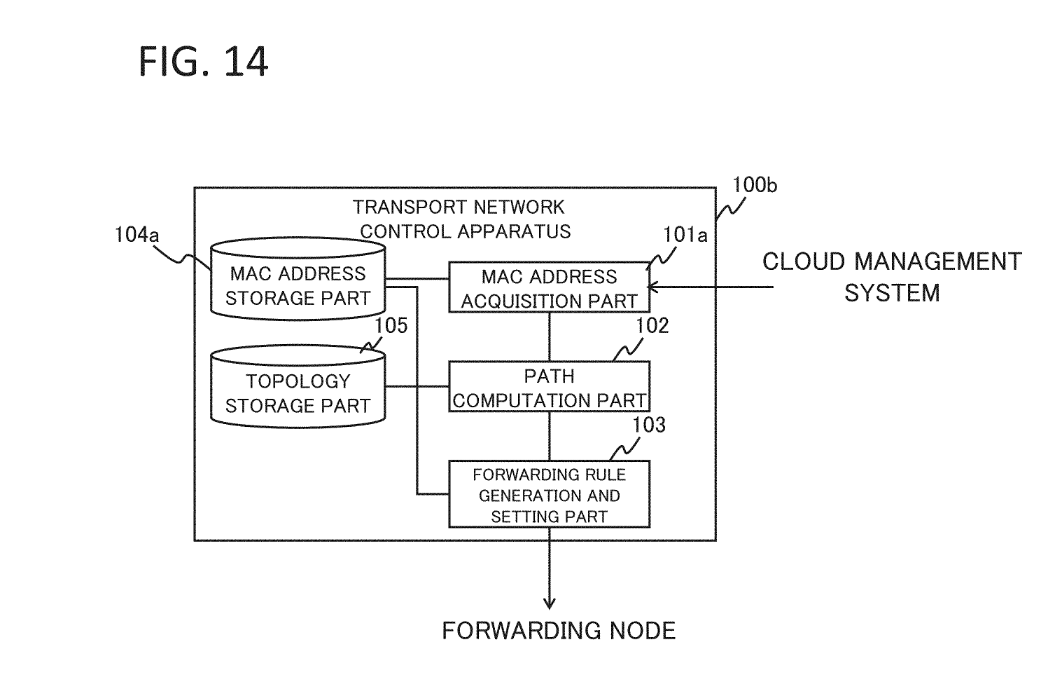

FIG. 14 is a diagram illustrating a configuration of a transport network control apparatus 100b in the third example embodiment of the present invention. A difference from the transport network control apparatus 100 in the first example embodiment illustrated in FIG. 4 resides in that a function of acquiring, together with a MAC address(es), identifiers for identifying a terminal having the MAC address and a virtual network of a virtual machine are added in a MAC address acquisition part 101a.

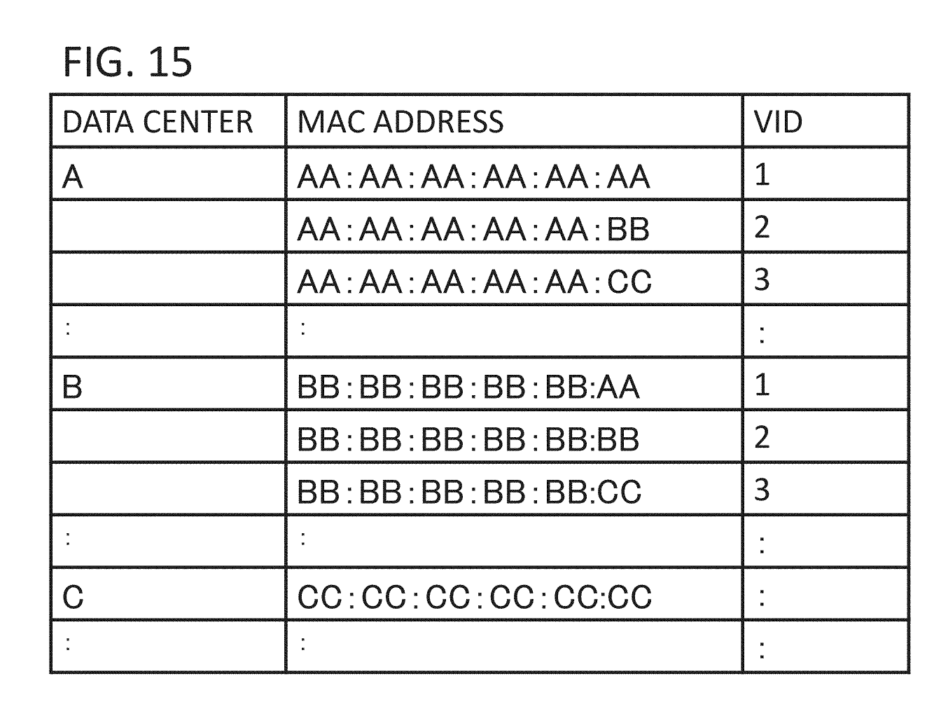

FIG. 15 is a table illustrating an example of a state where MAC addresses and virtual network identifiers are held in a MAC address storage part 104a in this example embodiment. In the example in FIG. 15, in addition to an ID for each data center (corresponding to the “base” described above) and a MAC address acquired from that data center, a VID (virtual network identifier) is stored in association with the ID for the data center and the MAC address.

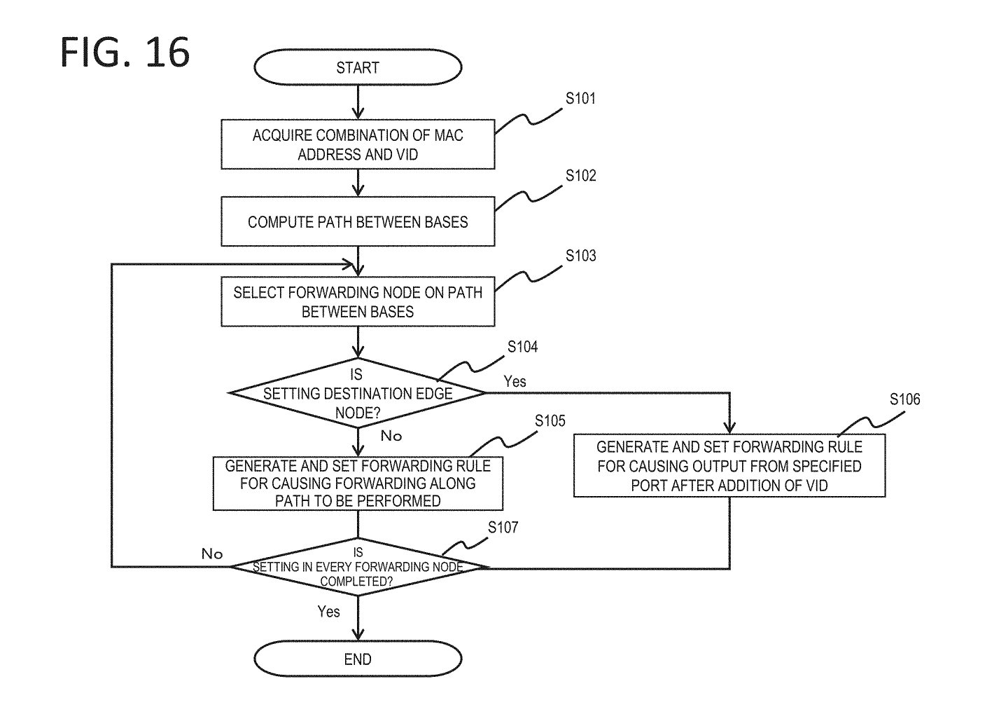

Then, operations in this example embodiment will be described in detail, with reference to the drawings. FIG. 16 is a flow diagram illustrating the operations of the transport network control apparatus in the third example embodiment. Referring to FIG. 16, the transport network control apparatus 100b first acquires a set of a MAC address and a network identifier from a cloud management system 200 configured to manage any one of data centers 400 (concerned) that is under its control and is connected to a transport SDN 300 (step S100).

Subsequently, the transport network control apparatus 100b computes a forwarding path for forwarding a frame between the data centers, by referring to topology information stored in a topology storage part 105 (step S102).

Then, the transport network control apparatus 100b selects one (destination as set) of forwarding nodes on the computed forwarding path and checks whether or not that forwarding node is an edge node connected to the data center (concerned) (steps S103 and S104). If the selected forwarding node is not the edge node, the transport network control apparatus 100b sets, in the forwarding node (concerned) 301, a forwarding rule so that the frame between the data centers properly reaches the data center of a destination, using the computed forwarding path and the acquired MAC address, as in the first example embodiment (step S105).

On the other hand, if the selected forwarding node is the edge node, the transport network control apparatus 100b generates a forwarding rule for causing a process of transmitting the corresponding frame to the data center after adding the VID held in the MAC address storage part 104a to be performed and sets the forwarding rule in the selected forwarding node (step S106). Though a method of adding the VID depends on the virtual network constructed on the data center, a method of using a VLAN ID field, a method of adding an MPLS label, other method of adding an additional header (outer header), or the like may be considered.

The transport network control apparatus 100b continues the processes after step S103 in FIG. 16 for every virtual network until setting in every forwarding node on the forwarding path is completed (step S107).

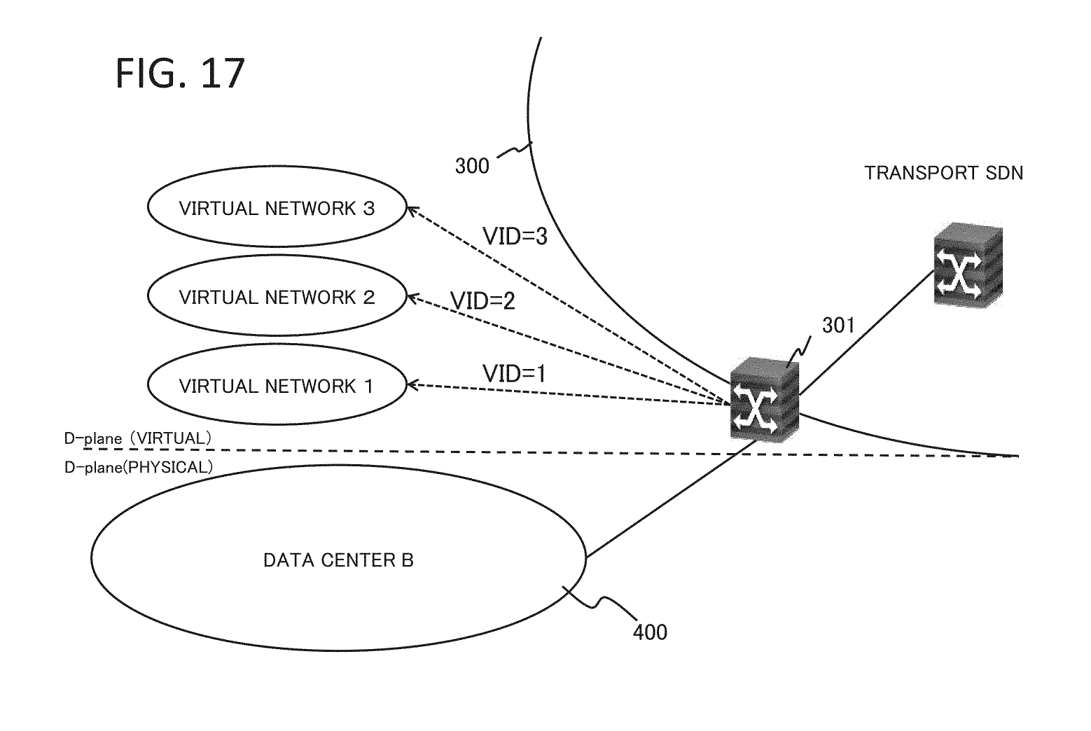

As a result of the above-mentioned processes, according to this example embodiment, the frame with the identifier (such as the VID) indicating any virtual network added thereto is transmitted to the data center, as illustrated in FIG. 17. As a result, a terminal or the like in the corresponding virtual network in the data center can receive the frame according to the identifier (VID) indicating the virtual network.

It is also possible to combine the above-mentioned third example embodiment and the above-mentioned second example embodiment. In this case, the edge node performs both of selective flooding of an unlearned frame and a transmission based on adding the identifier (VID) indicating the virtual network to a frame to be transmitted to the side of the data center.

Though the above description has been given about each example embodiment of the present invention, the present invention is not limited to the above-mentioned example embodiments. Further modification, substitution, or adjustment can be applied within a scope not deviating from the basic technical concept of the present invention. The network configuration, the configuration of each element, and the expression form of each message illustrated in each drawing, for example, are an example for helping understanding of the present invention and are not limited to the configurations illustrated in these drawings.

Finally, preferred modes of the present invention will be summarized.

### First Mode

(See the transport network control apparatus according to the first aspect).

### Second Mode

The transport network control apparatus mentioned above may be so configured that:
the means for computing the forwarding path computes a shortest path tree using a selected one of the bases as a root, thereby computing the forwarding path for forwarding the frame between the bases; and
the means for setting the forwarding rule shares the computed forwarding path for forwarding a frame between the bases.

### Third Mode

The transport network control apparatus mentioned above may be so configured that:
the transport network control apparatus manages, among a plurality of bases, a base(s) that serves as a destination(s) of the frame to be forwarded according to the forwarding rule and one or more bases other than the base(s) that serves as the destination(s); and
when a MAC address of a received frame does not match any forwarding rule, the transport network control apparatus causes an edge node of the transport network to perform flooding of the received frame to the one or more bases other than the base(s) that serves as the destination(s) of the frame to be forwarded according to the forwarding rule.

### Fourth Mode

The transport network control apparatus mentioned above may be so configured that:
the transport network control apparatus further comprises means for acquiring, from the cloud management system, a set of the MAC address and a virtual network identifier associated with the MAC address; and when the frame addressed to the base managed by the cloud management system is transmitted to the edge node connected to the base, the frame is transmitted after the virtual network identifier has been given to the frame.

### Fifth Mode

(See the communication system according to the second aspect).

### Sixth Mode

(See the forwarding node control method according to the third aspect).

### Seventh Mode

(See the program according to the fourth aspect).
The above-mentioned fifth to seventh modes can be developed into the second to fourth modes, like the first mode.

Each disclosure of the above-listed Patent Literatures is incorporated herein by reference. Modification and adjustment of each example embodiment and each example are possible within the scope of the overall disclosure (including the claims) of the present invention and based on the technical concept of the present invention. Various combinations and selections of various disclosed elements (including each element in each claim, each element in each example embodiment and each example, and each element in each drawing) are possible within the scope of the disclosure of the present invention. That is, the present invention naturally includes various variations and modifications that could be made by those skilled in the art according to the overall disclosure including the claims and the technical concept. With respect to a numerical value range described herein in particular, an arbitrary numerical value and a small range included in the numerical value range should be construed to be specifically described even unless otherwise explicitly described.

What is claimed is:

1. A transport network control apparatus, comprising:
a unit configured to acquire, from a cloud management system configured to manage a first base and a second base that are connected via a transport network configured to provide a layer 2 connection service, a MAC address to be used for a frame that is transmitted from any one of the bases;
a unit configured to compute, on the transport network, a forwarding path for forwarding the frame between the first and second bases using the MAC address as a destination; and
a unit configured to set, in a forwarding node on the transport network, a forwarding rule for causing the frame to be forwarded along the computed forwarding path.

2. The transport network control apparatus according to claim 1,
wherein the unit configured to compute the forwarding path computes a shortest path tree using a selected one of the bases as a root, thereby computing the forwarding path for forwarding the frame between the bases; and
the means for setting the forwarding rule shares the computed forwarding path for forwarding a frame between the bases.

3. The transport network control apparatus according to claim 1,
wherein the transport network control apparatus manages, among a plurality of bases, a base(s) that serves as a destination(s) of the frame(s) to be forwarded according to the forwarding rule and one or more bases other than the base(s) that serves as the destination(s); and
when a MAC address of a received frame does not match any forwarding rule, the transport network control apparatus causes an edge node of the transport network to perform flooding of the received frame to the one or more bases other than the base(s) that serves as the destination(s) of the frame to be forwarded according to the forwarding rule.

4. The transport network control apparatus according to claim 1, further comprising:
a second unit configured to acquire, from the cloud management system, a set of the MAC address and a virtual network identifier associated with the MAC address;
wherein when the frame addressed to the base managed by the cloud management system is transmitted to the edge node connected to the base, the frame is transmitted after the virtual network identifier has been given to the frame.

5. A communication system, comprising:
a transport network control apparatus including:
a unit configured to acquire, from a cloud management system configured to manage a first base and a second base that are connected via a transport network configured to provide a layer 2 connection service, a MAC address to be used for a frame that is transmitted from any one of the bases;
a unit configured to compute, on the transport network, a forwarding path for forwarding the frame between the first and second bases using the MAC address as a destination; and
a unit configured to set, in a forwarding node on the transport network, a forwarding rule for causing the frame to be forwarded along the computed forwarding path; and
at least one forwarding node on the transport network.

6. A forwarding node control method, comprising, by a transport network control apparatus connected to a cloud management system configured to manage a first base and a second base that are connected via a transport network configured to provide a layer 2 connection service:
acquiring, from the cloud management system, a MAC address to be used for a frame that is transmitted from any one of the bases;
computing, on the transport network, a forwarding path for forwarding the frame between the first and second bases using the MAC address as a destination; and
setting, in a forwarding node on the transport network, a forwarding rule for causing the frame to be forwarded along the computed forwarding path.

7. A non-transitory computer-readable recording medium storing thereon a program configured to cause a computer comprising a transport network control apparatus connected to a cloud management system configured to manage a first base and a second base that are connected via a transport network configured to provide a layer 2 connection service to execute:
acquiring, from the cloud management system, a MAC address to be used for a frame that is transmitted from any one of the bases;
computing, on the transport network, a forwarding path for forwarding the frame between the first and second bases using the MAC address as a destination; and
setting, in a forwarding node on the transport network, a forwarding rule for causing the frame to be forwarded along the computed forwarding path.
